(19) United States
(12) Patent Application Publication
(10) Pub. No.: US 2004/0024630 A1
(43) Pub. Date: Feb. 5, 2004

(54) Method and system for developing early design components of a software application

(76) Inventors: Rajeshwari Ganesan, Bangalore (IN); Shubhashis Sengupta, Bangalore (IN)

Correspondence Address: HELLER EHRMAN WHITE & MCAULIFFE LLP, 275 MIDDLEFIELD ROAD, MENLO PARK, CA, 94025-3506, US

(21) Appl. No.: 10/212,132

(22) Filed: Jul. 31, 2002

(51) Int. Cl. G06F 17/60

(52) U.S. Cl. 705/8; 705/10

(57) ABSTRACT

A method of developing early design components of a software application includes identifying business events. An object model or entity relationship diagram is drawn to identify the entities. A matrix is created to evaluate how the business events interact with the entities. Clustering is applied to identify a selected set of entity components (ECs) from the matrix. Process components (PCs) are then created from business events that are not methods of ECs.

### BACKGROUND OF THE INVENTION

1. Field of the Invention

This invention relates generally to software development, and more particularly to software development directed to designing components.

2. Description of the Related Art

The software development paradigm has changed over the years from procedural programming to object-oriented programming and further to component-based development (CBD). Software components are self-contained set of functionalities that have well defined interfaces and can be deployed independently for application composition. CBD has become a popular choice as it promotes reuse, reduces development cost and time-to-market. CBD methodologies describe how the software components are designed and how application systems are built from these components.

While many commercial and open-source component technologies are prevalent in the market; CBD methodologies, especially for designing the components, have not shown corresponding maturity. As opposed to a typical Object Oriented analysis and development (OOAD) process, which has well defined and practiced steps of Requirement specification (RS), requirement analysis (RA), design and implementation; the CBD process does not have well understood RA and design phases. For example, it is not researched well what are the early design components in CBD.

Generally, most of the published CBD methodologies discuss how to build systems by assembling pre-built components. Two of the most cited methodologies of this genre are SCIPIO and Catalysis. A methodology authored by Veryad called SCIPIO [R. Veryad, SCPIO: Aims, Principles and Structure, SCIPIO Consortium, April 1998] discloses how much of legacy (As-Is) artifacts can be used along with publicly available components to fit into the desired (To-Be) system. It does not use OO based approaches for requirements analysis. D'Souza and Wills, in their Catalysis approach [D. F. D'Souza and A. C. Wills, Objects, Components, and Frameworks with UML: the Catalysis Approach, Addison-Wesley, 1999] describe how families of products can be assembled from kits of pre-built commercial off the shelf (COTS) components. Both of these methods assemble component systems from pre-existing artifacts. Lee et al. [S. D. Lee, Y. J. Yang, E. S. Cho, S. D. Kim, S. Y. Rhew, COMO: A UML-Based Component Development Methodology, Proc. 6^{th} Asia Pacific Software Engineering Conference, Takamatsu, Japan, 1999] describe a methodology called COMO that is more suited to the custom software development and based on unified process. However, the primary concern of having a set of prescription for systematic creation of a set of early design components starting with a set of domain object models and use cases has not been addressed. In this invention, we address this prescriptive gap in the design of component-based applications.

There is a need for computer systems, apparatus and modules, and their methods of use, directed to designing components for software applications. There is a further need for computer systems, apparatus and modules, and methods of use, that are suitable for CBD in custom application development. There is yet another need for computer systems, apparatus, modules, and their methods of use, that are applicable to the analysis and design life-cycle stages of CBD. Yet there is a need to retain a distinction between process components (PC) and entity components (EC) in the output in order to separate the modeling in software applications of its entity information from process-related steps.

### SUMMARY OF THE INVENTION

Accordingly, an object of the present invention is to provide computer systems, modules, and their methods of use, directed to designing components for software applications.

Another object of the present invention is to provide computer systems, modules, and their associated methods of use, that are utilized to develop early design components for CBD.

Yet another object of the present invention is to provide computer systems, modules, and their methods of use, for determining entity and process components from object models such as Domain Object Model (DOM) and business event identification techniques such as external business events (EBE) and the resulting use cases or any equivalent process modeling.

A further object of the present invention is to provide computer systems, modules, and their methods of use, that determines how process components can be distinguished from entity components in CBD.

These and other objects of the present invention are achieved in a method of developing early design components of a software application. Business events are identified and entities are identified from an object model or an entity relationship diagram. A matrix is then created to depict how the business events interact with the entities. Clustering is applied to identify a selected set of ECs from the matrix. PCs are then created from business events that are not methods of ECs.

In another embodiment of the present invention, a method of developing early design components for CBD in a custom built application draws an object model or entity relationship diagram to identify entities in the application. External business events are identified. A matrix is then created to depict how the business events interact with the entities. Clustering is then applied to identify a selected set of ECs from the matrix. PCs are identified from the business events that are not methods of ECs.

In another embodiment of the present invention, a development module for developing early design components of a software application utilizing business event and an object model or entity relationship diagram has a matrix module that creates a matrix with entity-event interactions in response to the business events and the object model or entity relationship diagram. A clustering module is provided that applies clustering to identify a selected set of ECs from the matrix. An identification module identifies PCs from the business events that are not methods of ECs.

In another embodiment of the present invention, a computer system adapted to develop early design components of a software application includes a memory. The memory has software instructions that enable the computer system to perform the steps of, (i) creating a matrix to evaluate the entity-event interactions, (ii) applying clustering to identify a selected set of ECs from the matrix, and (iii) identifying PCs from the business events that are not methods to ECs.

### BRIEF DESCRIPTION OF THE DRAWINGS

FIG. 1 is a flowchart that illustrates one embodiment of methods and systems of the present invention utilized to develop early design components of software applications.

FIG. 2 is a representation of an object model for an order processing system cited by way of illustration of the present invention.

FIG. 3 is a representation of an entity-event interaction matrix for the business events and entities of the order processing system cited by way of illustration of the present invention.

FIG. 4 depicts an entity-event interaction matrix to show different clustering options by way of illustration of the present invention.

FIG. 5 is a representation of clustering technique applied to identify the entity components of order processing system cited by way of illustration of the present invention.

FIG. 6 is a block diagram illustrating one embodiment of the modules in the present invention.

### DESCRIPTION OF THE PREFERRED EMBODIMENTS

Referring to FIG. 1, one embodiment of the present invention provides a method, and associated computer systems, apparatus and modules, for developing early design components, used for early design components in a custom-built component-based software application by software-application designers, programmers, system analysts, and the like.

For custom application developers and designers of early design components, it is important to begin with a set of object models or entity relationship diagrams, and use cases. Developers and designers in OO paradigm begin with object models or entity relationship diagrams because it provides informational model and use cases that yield behavioral models of an application system. Without loss of generality, the words “application system” as used in this specification defines a set of business functionalities. By way of illustration, and without limitation, an example of an application system is a purchase order processing system (OPS), a library system, an auction house and the like. Aspects relating to a physical model design of an application system are required before a computer model of that application system can be developed. Object models and use cases represent this physical model design. Object models provide “who” or “what” constitute an application system and use cases depict “how” they interact (system behavior) to an external business event.

In various embodiments of the present invention, Business events are used to identify the external events acting on the application system. One example of a business event is an external business event (EBE), as more fully described in S. J. McMenamin and J. F. Palmer, Essential Systems Analysis, Prentice-Hall, N.J., 1984, incorporated herein by reference. Domain Object Model (DOM) is an example of an object model.

In various embodiments of the present invention, business events are utilized in order to view the application system under development that responds to events which occur outside the boundary of the application system. An important characteristic of a business event is that the application system comes to rest after responding to the event. In other words, once the application system completes its planned response to a business event, it returns to a state of rest until another event impinges on it. A use case may then be viewed as the application system's response to a business event; i.e., a use case is the sequence of actions by the application system that takes place in response to a business event. In this manner business events do not interact with or trigger each other. That is, each event, and its associated use case, provides a self-contained functional slice of the application system. An object model or entity relationship diagram is drawn to identify the main business entities of the application system and their relationships. The business events and the object model or entity relationship diagram, are then used to create a matrix that includes an entity-event interaction.

By way of illustration, and without limitation, the present invention can be utilized in an order processing system (OPS). Briefly, the requirements of the OPS are:

Tender notices are released every month and registered vendors bid for it.

The vendor's bid states the bid amount and the required time to fulfill the order.

The purchase order department awards consignment to a vendor based on vendor ratings. These ratings are based on parameters such as his current bid price, quoted time to fulfill the order and his average service levels, and the like. The average service level of a vendor is based on its past price quotations, timeliness and quality of products delivered. A consolidated rating based on these parameters is used as the basis for assessment. The department does all the required follow-ups and ensures the completion of the consignment. Table 1 lists some business events for the OPS.

TABLE I
List of business events in an Order Processing System

| S1 No. | Event ID | Description |
|---|---|---|
| 1 | M1 | Create an purchase order |
| 2 | M2 | Receive items |
| 3 | M3 | Request for vendor rating |
| 4 | M4 | Cancel an order |
| 5 | M5 | Register a vendor |
| 6 | M6 | Cancel a vendor |

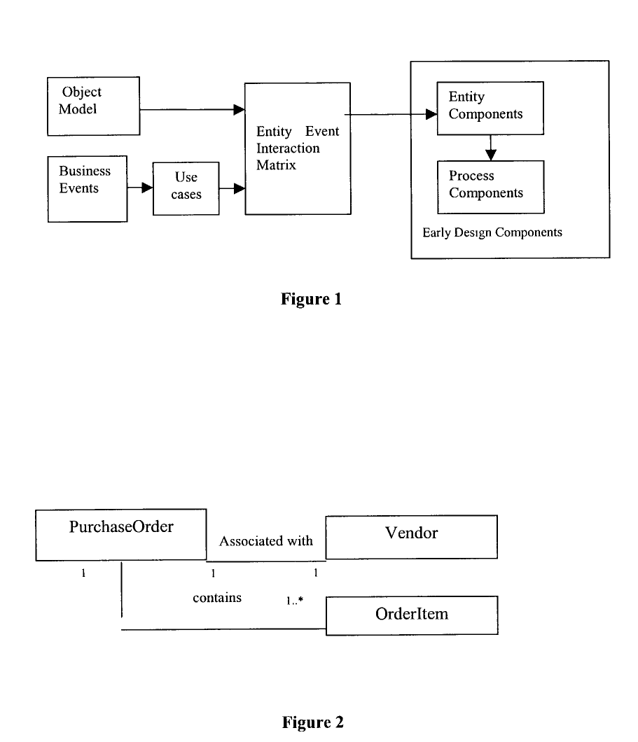

FIG. 2 refers to the object model of the OPS and illustrates the business entities, such as PurchaseOrder, Vendor, and OrderItem, their relationships and cardinalities of the relationship (e.g. a Vendor is associated with one PurchaseOrder etc.).

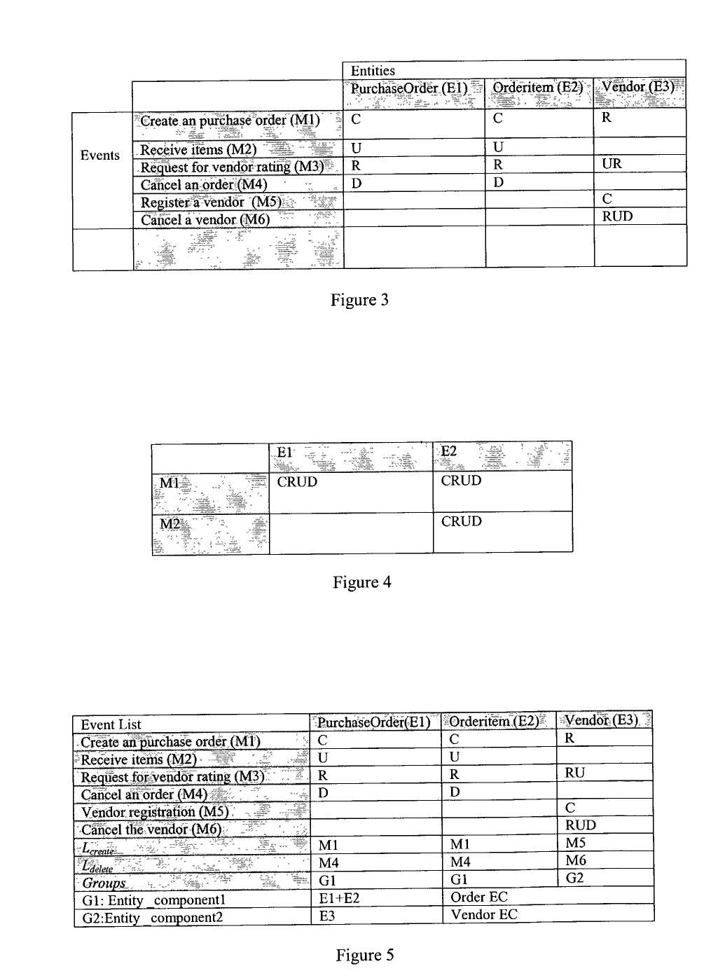

Referring now to FIG. 3, in the methods, computer systems and modules of the present invention, an entity-event interaction matrix is created that captures the interaction between the business events and the entities. The columns and rows in the matrix are interchangeable. In one embodiment, the entities are represented in columns and the business events are in the rows. The rows and columns have intersections defined by the interaction types: create (C), read (R), update (U), and delete (D).

In various embodiments, (i) C is marked when an event that creates the entity, (ii) R is marked when an event that reads data from the entity (iii) U is marked when an event that updates the entity data and (iv) D is marked when an event that deletes the entity.

For purposes of the present invention, entities can have any type of data including but not limited to any variable: integer, float, string, structure, array, and the like. Each entity has its own data structure. By way of illustration, a Vendor entity can have an ID (Long Integer), a Name (String), Age/DOB (Integer/Date), Sex (Boolean), Address (String), Social security number (String), credit card number (String), and the like. Creation/updation can populate some or all of these fields.

This entity-event interaction matrix of the present invention representation permits ruling out certain groupings of entities based on criteria such as referential integrity. C and D, Create and Delete, constrain the ways in which entities can be grouped. By way of illustration, and without limitation, two business events, M1 and M2, interact with entities E1 and E2 as illustrated in FIG. 4. Again by way of illustration there can be two different grouping options, Option 1: where E1, E2 map to Entity Component; and Option 2: where E1 maps to Entity Component1 and E2 maps to Entity Component2. With Option 1, the event M2 creates referential integrity problems with the C and D operations.

With the C operation, M2 has logic only to initialize or assign values to fields that correspond to E2. This may violate certain other rules or conditions for the fields in E1. Hence, only option 2 is a valid mapping. The entity-event interaction matrix of the present invention reduces and can eliminate invalid grouping possibilities. Conversely two entities are possible candidates for grouping/clustering if they have identical events that create and delete them.

In various embodiments of the present invention, for each entity a list Lcreate of business events is made that creates the entity, and a list Ldelete of business events is made that deletes the entity. Groups of entities that have the same Lcreate and Ldelete list are collated. Entities that have the same Lcreate and Ldelete list are grouped into an Entity Components (EC). Groups identified by the clustering are then selected for the purpose of giving a set of possible large-grained Entity Components. As illustrated in FIG. 5, the OPS has two ECs: Order EC and Vendor EC.

In another embodiment of the present invention, the methods and modules of the present invention retain a distinction between process and entity components in the output. Entity components model ‘entity information’ in an application system, by way of illustration database records. Process components relate to a particular activity sequence or workflow. By way of illustration, and without limitation, the activities in OPS can be represented by process components while the Vendor, a persistent container (or part thereof) of records is represented by an entity component. Because the entity and process components serve distinct purposes their distinction is maintained in the design of the early stage components of the application system.

Various embodiments of the present invention provide a distinction between the ECs and PCs. All business events that can be expressed as a natural method to an EC are eliminated in order to determine the PC's as illustrated in Table 2. For purpose of illustration, and without limitation, an example of natural methods are member functions associated with a class in OO paradigm.

In the OPS example, a business event can be that a user of OPS wants to register a vendor (E # M5). In response to this event, the Vendor Object, where the Vendor Object is an implementation embodiment of an EC, can invoke a method Vendor.register( ). This business event, therefore, is not a candidate for being a Process Component. Any business event that cannot be naturally be ascribed to any entity object is a suitable candidate for becoming a PC. This can be achieved when, (i) the event itself is too complex to be modeled as a method on an entity object (which may in turn call other methods on other entities), (ii) the event has pieces of constituent functionality that show similar behavior (i.e., cannot be modeled as a method on an entity object).

Continuing with the OPS example from above, a user of the application system can make an inquiry regarding the rating of a particular vendor (E # M3). This requires orchestration of a task between more than one EC. To rate a vendor, including but limited to vendor information such as price, quality, timeline, and the like, the present invention can invoke methods on both Order and Vendor ECs and can also call for some database entries. E #M3 maps to a VendorRating Process Component (PC). For ease of classification, the entity-event interaction matrix can be re-written with business events as rows and ECs as columns.

TABLE 2
THE FOLLOWING BUSINESS EVENTS ARE NOT PCs

Event M1 → Order.CreatePO( );
Event M2 → Order.ReceiveItems( );
Event M4 → Order.Cancel( );
Event M5 → Vendor.Register( );
Event M6 → Vendor.CancelVendor( );

In another embodiment of the present invention, a method of developing early design components for CBD in a custom application draws object models or entity relationship diagrams to identify entities in the application. Business events are then identified. In response to the business events and the object models or entity relationship diagrams, a matrix is created that includes entity-event interactions. Clustering is applied to identify a selected set of ECs from the matrix. PCs are then identified from the ECs and the business events.

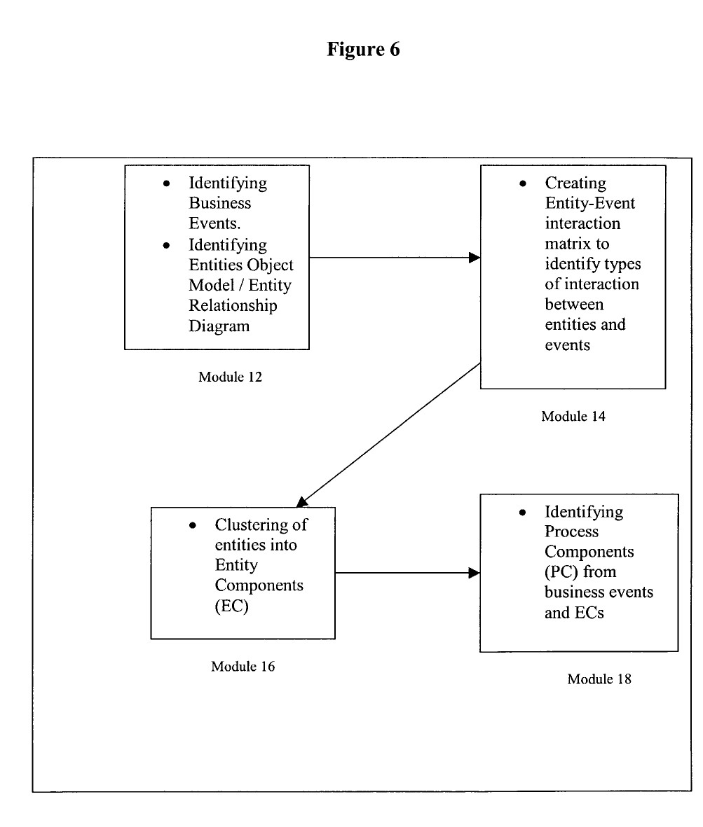

Referring now to FIG. 6, another embodiment of the present invention provides a development module 10 for developing early design components of a software application. A first identification module 12 is included to identify the business events and create an object model or entity relationship diagram. A matrix module 14 creates a matrix that includes entity-event interactions between the entities and the business events. A clustering module 16 is included and configured to apply clustering to identify the selected set of ECs from the matrix. A second identification module 18 is provided that identifies PCs from the ECs and the EBEs. Development module 10 can be utilized to develop early design components for CBD in a custom application and implements the methods described above.

Additionally, another embodiment of the present invention is a computer system that includes a memory with software instructions that execute the methods described above.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A method of developing early design components of a software application, comprising:
identifying business events and drawing an object model or an entity relationship diagram;
creating a matrix that includes interactions between the business events and entities obtained from the object model or entity relationship diagram;
applying clustering to identify a selected set of ECs from the matrix; and
creating PCs from business events that are not methods to ECs.

2. The method of claim 1, wherein the business event is an EBE.

3. The method of claim 2, wherein the object model is a DOM.

4. The method of claim 1, wherein the matrix includes columns and rows with the entities represented in columns and the business events represented in rows.

5. The method of claim 2, wherein the columns and rows are interchangeable.

6. The method of claim 4, wherein the rows and columns have intersections, each of an intersection having an interaction type between the rows and columns.

7. The method of claim 6, wherein the interaction type is selected from create (C), read(R), update (U) and delete(D).

8. The method of claim 7, wherein C is marked when a business event creates the entity.

9. The method of claim 7, wherein R is marked when a business event reads data from the entity.

10. The method of claim 7, wherein U is marked when a business event updates the entity data.

11. The method of claim 7, wherein D is marked when a business event deletes the entity.

12. The method of claim 1, wherein the step of applying clustering includes for each entity making a list Lcreate of business events that creates the entity.

13. The method of claim 12, wherein the step of applying clustering includes for each entity making a list Ldelete of business events that delete the entity.

14. The method of claim 13, wherein the step of applying clustering includes collating groups of entities that have the same Lcreate and Ldelete list.

15. The method of claim 14, further comprising:
grouping entities that have the same Lcreate and Ldelete list into an EC.

16. The method of claim 14, further comprising:
selecting groupings identified by the clustering.

17. The method of claim 1, wherein the step of identifying PCs includes, redrawing the matrix with business events as rows and ECs as columns.

18. The method of claim 17, wherein the step of identifying PCs includes, eliminating all business events that can be expressed as a natural method to an EC.

19. The method of claim 18, wherein business events that are not assigned to an EC are suitable for becoming PCs.

20. A method of developing early design components for CBD in a custom build application, comprising:
drawing an object model or entity relationship diagram to identify entities in the application;
identifying business events;
creating a matrix that includes interactions between the business events and entities obtained from an object model or entity relationship diagram;
applying clustering to identify a selected set of ECs from the matrix; and
identifying PCs from the business events that are not methods of ECs.

21. The method of claim 20. wherein the business event is an EBE.

22. The method of claim 21, wherein the object model is a DOM.

23. The method of claim 20, wherein the matrix includes columns and rows with the ECs represented in columns and the business events represented in rows.

24. The method of claim 23, wherein the columns and rows are interchangeable.

25. The method of claim 23, wherein the rows and columns have intersections, each of an intersection having an interaction type between the rows and columns.

26. The method of claim 25, wherein the interaction type is selected from create (C), read(R), update (U) and delete (D).

27. The method of claim 26, wherein C is marked when a business event creates the entity.

28. The method of claim 26, wherein R is marked when a business event reads data from the entity.

29. The method of claim 26, wherein U is marked when a business event updates the entity data.

30. The method of claim 26, wherein D is marked when a business event deletes the entity.

31. The method of claim 20, wherein the step of applying clustering includes for each entity making a list Lcreate of business events that creates the entity.

32. The method of claim 31, wherein the step of applying clustering includes for each entity making a list Ldelete of business events that delete the entity.

33. The method of claim 32, wherein the step of applying clustering includes collating groups of entities that have the same Lcreate and Ldelete list.

34. The method of claim 33, further comprising:
grouping entities that have the same Lcreate and Ldelete list into an EC.

35. The method of claim 33, further comprising:
selecting groupings identified by the clustering.

36. The method of claim 20, wherein the step of identifying PCs includes, redrawing the matrix with business events as rows and ECs as columns.

37. The method of claim 36, wherein the step of identifying PCs includes, eliminating all business events that can be expressed as a natural method to an EC.

38. The method of claim 37, wherein business events that are not assigned to an EC are suitable for becoming PCs.

39. A development module for developing early design components of a software application utilizing business events and an object model or entity relationship diagram, comprising:
a module to identify business events and an object model or an entity relationship diagram;
a matrix module that creates a matrix that includes entity-event interactions in response to the business events and the object model or entity relationship diagram;
a clustering module configured to apply clustering to identify a selected set of ECs from the matrix; and
an identification module that identifies PCs from business events that are not methods of ECs.

40. The module in claim 39, wherein the business event is an EBE.

41. The module of claim 40, wherein the object model is a DOM.

42. The module of claim 39, wherein the matrix includes columns and rows with the ECs represented in columns and the business events represented in rows.

43. The module of claim 42, wherein the columns and rows are interchangeable.

44. The module of claim 42, wherein the rows and columns have intersections, each of an intersection having an interaction type between the rows and columns.

45. The module of claim 44, wherein the interaction type is selected from create (C), read(R), update (U) and delete(D).

46. The module of claim 45, wherein C is marked when a business event creates the entity.

47. The module of claim 45, wherein R is marked when a business event reads data from the entity.

48. The module of claim 45, wherein U is marked when a business event updates the entity data.

49. The module of claim 45, wherein D is marked when a business event deletes the entity.

50. The module of claim 39, wherein the step of applying clustering includes for each entity making a list Lcreate of business events that creates the entity.

51. The module of claim 50, wherein the step of applying clustering includes for each entity making a list Ldelete of business events that delete the entity.

52. The module of claim 51, wherein the step of applying clustering includes collating groups of entities that have the same Lcreate and Ldelete list.

53. The module of claim 52, further comprising:
grouping entities that have the same Lcreate and Ldelete list into an EC.

54. The module of claim 53, further comprising:
selecting groupings identified by the clustering.

55. The module of claim 39, wherein the step of identifying PCs includes, redrawing the matrix with business events as rows and ECs as columns.

56. The module of claim 55, wherein the step of identifying PCs includes, eliminating all business events that can be expressed as a natural method to an EC.

57. The module of claim 56, wherein business events that are not assigned to an EC are suitable for becoming PCs.

58. A computer system adapted to develop early design components of a software application, comprising:
a memory including software instructions adapted to enable the computer system to perform the steps of:
creating a matrix that includes entity-event interactions between entities and business events;
applying clustering to identify a selected set of ECs from the matrix; and
identifying PCs from the business events that are not methods to ECs..

59. The system of claim 58, wherein a business event is an EBE.

60. The system of claim 59, wherein the object model is a DOM.
